(19) United States
(12) Patent Application Publication
(10) Pub. No.: US 2015/0356605 A1
(43) Pub. Date: Dec. 10, 2015

(54) METHODS FOR COMMERCIALIZING INNOVATIONS

(71) Applicant: Ali Albassami, Blacksburg, VA (US)

(72) Inventor: Ali Albassami, Blacksburg, VA (US)

(21) Appl. No.: 14/295,979

(22) Filed: Jun. 4, 2014

(51) Int. Cl. G06Q 30/02

(52) U.S. Cl. CPC G06Q 30/0261; G06Q 30/0269; G06Q 40/06

(57) ABSTRACT

Innovation information is received pertaining to at least one benefit that an innovation would offer an international market. This innovation information is then matched to at least one country, at least one market, and at least one business that satisfy cultural, political, and economic factors. Stakeholders are identified having shared characteristics with the innovation based on the countries, markets, and businesses that have been matched to the innovation information. Activities and resources are that are required to commercialize the innovation are identified and then distributed among the stakeholders. A feasibility report and a business plan are developed that detail the technical, marketing, and business attributes of commercializing the innovation so that the stakeholders can decide if they should commercialize of the innovation.

### GRANT OF NON-EXCLUSIVE RIGHT

This application was prepared with financial support from the Saudia Arabian Cultural Mission, and in consideration therefore the present inventor has granted. The Kingdom of Saudi Arabia a non-exclusive right to practice the present invention.

### BACKGROUND

Taking an innovation from initial development to commercialization on an international scale presents challenges that often prevent innovations from reaching their ideal consumers. Some of these challenges include having difficulties providing adequate discoverability opportunities for an innovative product without having unsolicited contacts and duplicate work, ineffective communication and collaboration by stakeholders, and making uninformed decisions regarding whether to move forward with commercialization of the innovation.

In view of the above, it is desirable to determine an operational roadmap for taking a fully developed, innovative product and preparing it for launch in a national or international market. The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

### SUMMARY

Innovation information is received pertaining to at least one benefit that an innovation would offer an international market. This innovation information is then matched to at least one country, at least one market, and at least one business that satisfy cultural, political, and economic factors. Stakeholders are identified having shared characteristics with the innovation based on the countries, markets, and businesses that have been matched to the innovation information. Activities and resources are that are required to commercialize the innovation are identified and then distributed among the stakeholders. A feasibility report and a business plan are developed that detail the technical, marketing, and business attributes of commercializing the innovation so that the stakeholders can decide if they should commercialize of the innovation.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the present advancements and many of the attendant advantages thereof will be readily obtained as the same becomes better understood by reference to the following detailed description when considered in connection with the accompanying drawings. However, the accompanying drawings and their exemplary depictions do not in any way limit the scope of the advancements embraced by the specification. The scope of the advancements embraced by the specification and drawings are defined by the words of the accompanying claims.

FIG. 1 is a schematic diagram of a system for internationally commercializing a residential construction innovation according to an exemplary embodiment;

FIG. 2 is a system flowchart for internationally commercializing a residential construction innovation according to an exemplary embodiment;

FIG. 3A is an information flow diagram of a system for performing the needs and offers matching phase of internationally commercializing a residential construction innovation according to an exemplary embodiment;

FIG. 3B is an information flow diagram of a system for performing the stakeholders networking phase of internationally commercializing a residential construction innovation according to an exemplary embodiment;

FIG. 4 is an information flow diagram of a system for performing the feasibility study phase of internationally commercializing a residential construction innovation according to an exemplary embodiment; and

FIG. 5 is a schematic diagram of an innovation commercialization device for internationally commercializing a residential construction innovation according to an exemplary embodiment.

### DETAILED DESCRIPTION OF THE EMBODIMENTS

Referring now to the drawings, wherein like reference numerals designate identical or corresponding parts throughout the several views, the following description relates to a device and associated methodology for determining a business plan and feasibility study predicting the likelihood of success of commercializing an innovation on an international scale. Specifically, an innovation commercialization device receives commercialization data pertaining to the residential construction innovation. Through a series of phases, this device determines an operational roadmap for taking a fully developed product and preparing it for launch in a national or international market. The phases include, in selected embodiments, matching what the innovation offers with the businesses that are selected to implement it, networking stakeholders in the product's supply chain, and conducting a feasibility study. In one implementation, these phases are executed sequentially and receive the output from the previous phase as well as user input in order to carry out their processes. In other aspects, these phases may be executed concurrently or in a different order so that adjustments to the scope of the innovation or changes in the phases of implementation of the innovation can be made in real time.

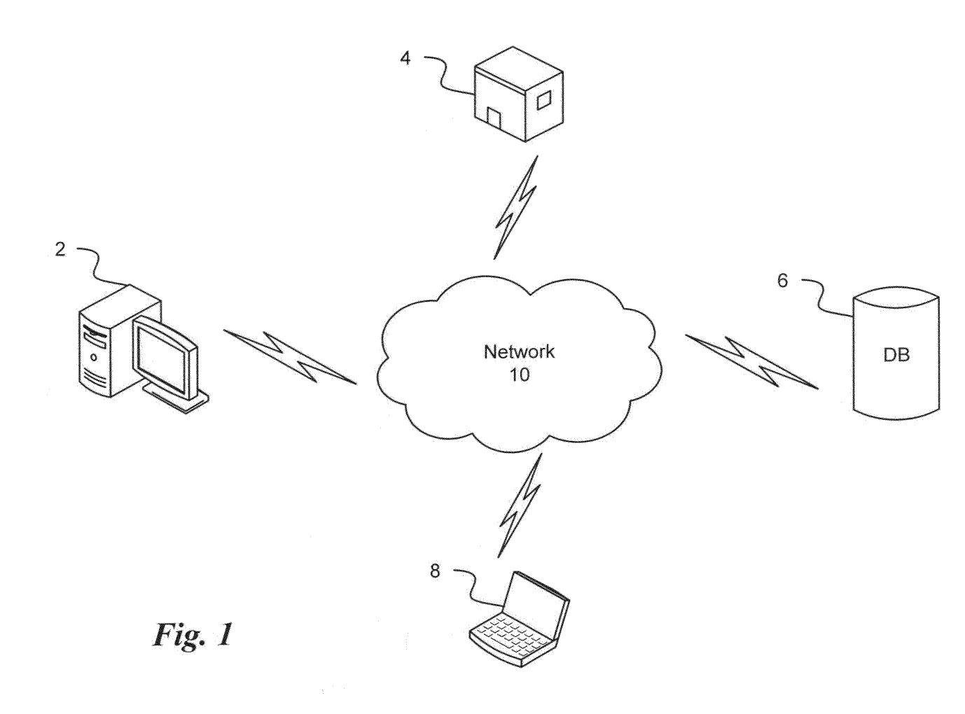

FIG. 1 is a schematic diagram of a system for internationally commercializing an innovation. In FIG. 1, a computer 2 is connected to a server 4, a database 6 and a mobile device 8 via a network 10. The server 4 represents one or more servers connected to the computer 2, the database 6 and the mobile device 8 via the network 10. The server 2 may interchangeably be known as the innovation commercialization device as described further herein. The database 6 represents one or more databases connected to the computer 2, the server 4 and the mobile device 8 via network 10. The mobile device 8 represents one or more mobile devices connected to the computer 2, the server 4 and the database 6 via the network 10. The network 10 represents one or more networks, such as the Internet, connecting the computer 2, the server 4, the database 6 and the mobile device 8.

The computer 2 includes an interface, such as a keyboard and/or mouse, allowing a user to input innovation information pertaining to an innovation which is then transmitted to the server 4 via network 10. In selected embodiments, the innovation pertains to the residential construction industry, and the innovation information may include in part construction specifications, product data sheets, material safety data sheets, equipment, parts and materials, recommended labor qualifications, and implementation instructions as would be recognized by one of ordinary skill in the art. However, the innovation can also relate to any aspect of the construction industry, electronics technologies, or any type of newly developed product that could be produced and sold in a market.

Once the innovation information is received by the server 4, the server 4 uses the innovation information to query the database 6 via network 10 to complete a needs and offers matching phase of internationally commercializing the innovation. This information, along with any information manually input by the user that may include characteristics of a prospective country, market, or business at computer 2, is then used by the server 4 to generate a list of one or more compatible international or national businesses, as will be discussed, through a matching process. Once the compatible international businesses have been matched, a list of these businesses along with their corresponding compatible features is saved in memory of the server 4 and/or computer 2/mobile device 8 and then served by the server to the computer 2 to be displayed on the display screen of computer 2 and can also be sent to a variety of external devices, such as a mobile device 8, via a text, e-mail, or any other related method.

The list of compatible businesses that was generated by the server 4 is then used by the server 4 to complete the stakeholders networking phase of internationally commercializing the innovation. This information, along with any information generated by the server 4 or manually input by the user that may include preferred business partners, a list of tasks to be performed, and a list of resources to be performed at computer 2, is then used by the server 4, as will be discussed, to allow the stakeholders to negotiate the distribution of identified tasks and resources via an interface at the computer 2 and/or mobile device 8. Once the stakeholders have completed negotiations, the server 4 generates negotiation information that specifies the activities and resources assigned to each stakeholder. This negotiation information is saved in memory of the server 4 and/or computer 2/mobile device 8 and then displayed on the display screen of computer 2 and can also be sent to a variety of external devices, such as a mobile device 8, via a text, e-mail, or any other related method.

The negotiation information that was generated by the server 4 is then used by the server to query the database 6 via network 10 to complete the feasibility study phase of internationally commercializing the innovation. This negotiation information, along with any information manually input by the user that may include technical, marketing, and business details of commercializing the innovation at computer 2, is then used by the server 4 to generate, as will be discussed, a feasibility report and business plan for the stakeholders to analyze. Once the feasibility report and business plan have been generated, this information is saved in memory and then displayed on the display screen of computer 2 and can also be sent to a variety of external devices, such as a mobile device 8, via a text, e-mail, or any other related method. The stakeholders can then use this feasibility report and business plan to make a final decision about whether to execute the commercialization of the innovation via an interface at the computer 2.

As would be understood by one of ordinary skill in the art, based on the teachings herein, the mobile device 8 or any other external device could also be used in the same manner as the computer 2 to receive the innovation information and manually input information from an interface and send the innovation information and manually input information to server 4 and database 6 via network 10 to complete the needs and offers matching phase, stakeholders networking phase, and feasibility study phase. In one implementation, a user, such as a stakeholder, uses an application on his or her SmartPhone to negotiate with other stakeholders in the supply chain to distribute the list of tasks and resources among each other as well as to update other stakeholders regarding the status of completing his assigned tasks or procuring his assigned resources.

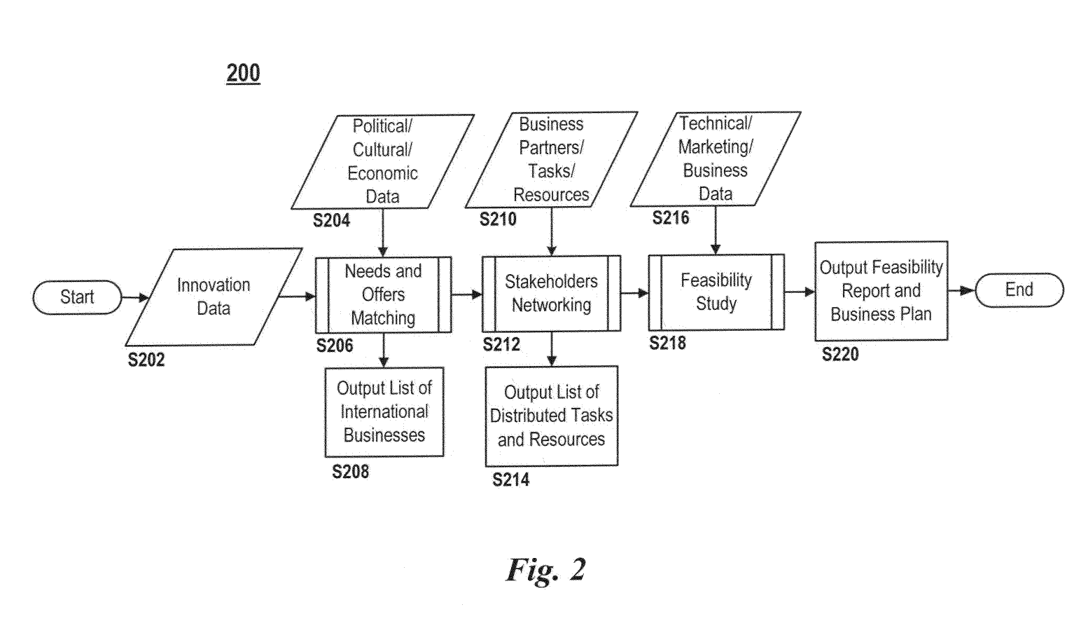

A flowchart of a framework for internationally commercializing an innovation 200 is described by FIG. 2. A user inputs innovation information at step S202 pertaining to the innovation at a computer interface, such as a computer 2 and/or mobile device 8, which is then transmitted to the server 4 via network 10. In one aspect where the innovation pertains to the residential construction industry, the innovation information could include construction specifications, product data sheets, material safety data sheets, equipment, parts and materials, recommended labor qualifications, and implementation instructions as would be recognized by one of ordinary skill in the art. This innovation information is then used as an input to the needs and offers matching phase at step S206.

At step S204, the server 4 obtains political, cultural, and/or economic factors retrieved from a database 6 along with any information manually input at computer 2 by the user regarding additional factors that may affect the commercialization of the innovation. In one aspect, the political, cultural, and/or economic factors may include the number and type of international businesses already established in a particular country, legal structures already in place that support international business, or an economic growth rate of a country or business market. The global, market, and business factors that are obtained at step S204 are used as inputs to the needs and offers matching phase at step S206.

At step 206, in the needs and offers matching phase, the server 4 identifies countries, markets, and businesses that are related to the innovation information that was input at step S202 but also meet the political, cultural, and economic criteria that were established at step S204. The processor, which includes processing circuitry, then matches the innovation information to the political, cultural, and economic factors on the global, market, and business levels.

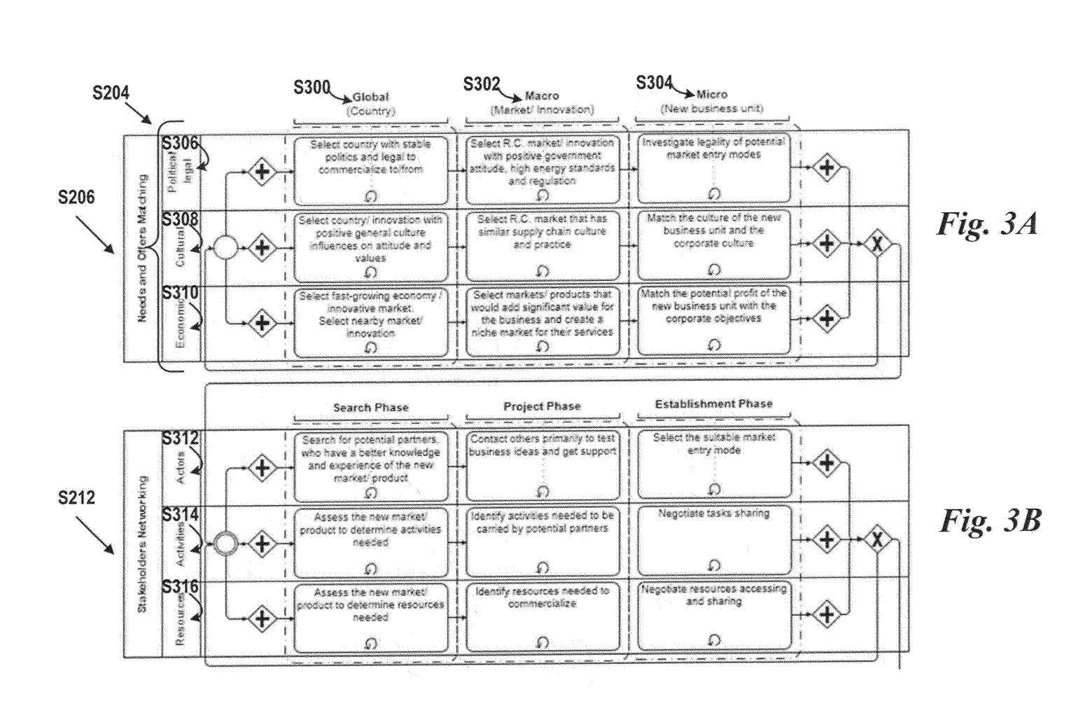

At step S208, the list of international businesses that have been matched to the innovation information during the needs and offers matching phase at step 206 is output by the server 4 to the mobile device 8 and/or computer 2. The originator of the innovation may then select one or more of the matched international businesses for executing the commercialization of the innovation. Further exemplary details of the needs and offers matching phase at step S206 are described below with reference to FIG. 3A.

Descriptive information pertaining to the one or more matched international businesses selected by the originator of the innovation at step S208 is an input to the stakeholders networking phase at step S212. At step 210, the server 4 obtains data pertaining to preferred business partners, tasks to be performed, and/or resources to be acquired that are retrieved from a database 6 along with any information manually input at computer 2 by the user. This data obtained at step S210 is an input to the stakeholders networking phase at step S212. The stakeholders networking phase at step S212 determines the finalized list of stakeholders and enables the stakeholders to negotiate the distribution of identified tasks and resources via an interface at the computer 2 and/or mobile device 8. At step 214, a list of distributed tasks and resources that was determined by the stakeholders networking phase at step 212 is output by the server 4 at step S214. Further exemplary details of the stakeholders networking phase at step S212 are described below with reference to FIG. 3B.

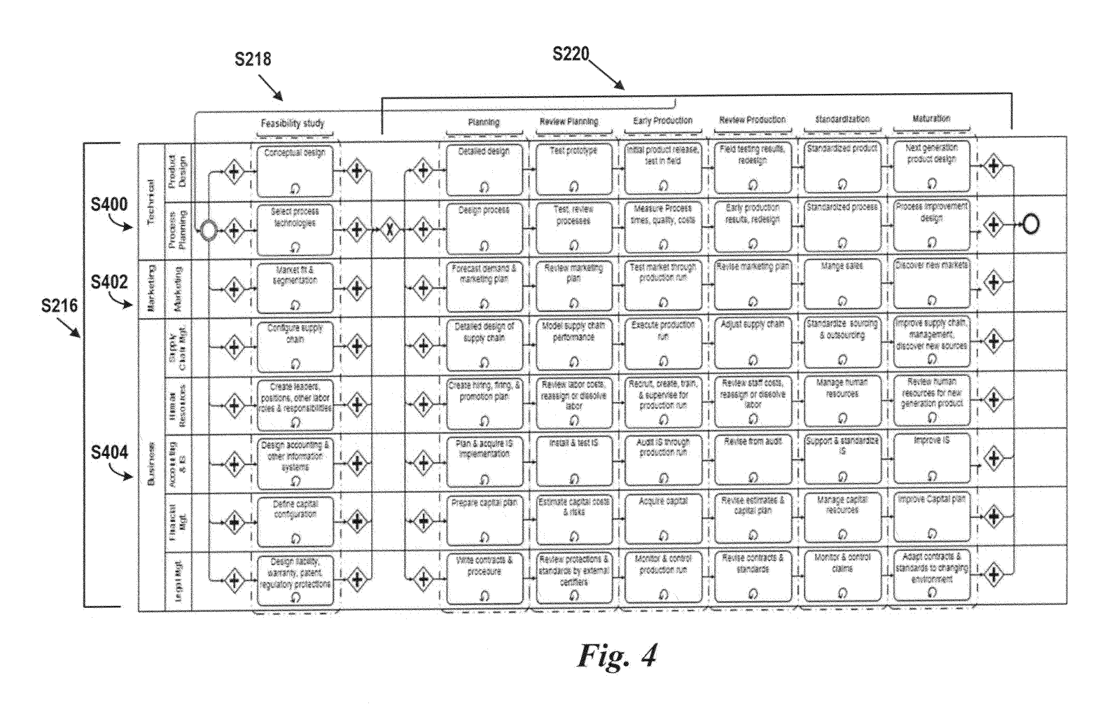

The list of negotiated tasks and resources output by the server at step S214 is also an input to the feasibility study phase at step S218. At step S216, the server 4 outputs data pertaining to technical, marketing, and/or business details of commercializing the innovation retrieved from a database 6 along with any information manually input at computer 2 and/or mobile device 8 by the user. The technical, marketing, and/or business data obtained at step S216 is then input to the feasibility study phase at step S218. In the feasibility study phase of step S218, a business plan and feasibility report are developed and output by the server 4. The output of the feasibility study phase at step S218 is a feasibility report and business plan for the stakeholders to use to decide whether to move forward with executing the implementation of the innovation. Further exemplary details of the feasibility study phase S218 are described below with reference to FIG. 4.

An information flow diagram for performing the needs and offers matching phase at step S206 of internationally commercializing an innovation is described by FIG. 3A. The innovation information obtained at step S202 is matched to political and legal factors of the international market place at step S306, cultural factors of the international market place at step S308, and economic factors of the international market place at step S310 across global domains at step S300, macro domains at step S302, and micro domains at step S304. The political, cultural, and economic factors that are matched to the innovation data are retrieved from a database along with any information manually input at computer 2 by the user at step S204. Any of the following steps of matching the innovation information to political, cultural, and economic factors associated with innovation commercialization across global, macro, and micro domains may be performed in series, concurrently, or in a different order according to other implementations.

At step S306, the political and legal factors associated with innovation commercialization are matched to the innovation information across the global, macro, and micro domains. On the global level at step S300, countries are identified that have a stable political environment and that have legal structures in place that support international business. For example, whether a particular country has a democratic, authoritarian, totalitarian, or some other type of state may affect the steps international companies have to take to conduct business. A country's tax laws can also have an impact on international businesses. For example, some countries lower their corporate tax rates to encourage business development. Regarding the residential construction industry in particular, regulations imposed by the government may help support a safe, cost-effective, and timely implementation of the residential construction innovations. These regulations may include building codes, construction testing requirements, and construction safety requirements. In addition, governments that support organizations similar to the United States Green Building Council or certifications similar to the United States' Leadership in Energy and Environmental Design (LEED) are more likely to ensure that the residential construction industry is creating residences that are sustainable, energy-efficient, and built with a minimal amount of waste.

From the countries identified at step S300, at step S302, markets are identified with a predetermined standard of regulation by a local government as discussed above. Examples of markets in the residential construction industry include various construction-related disciplines such as electrical, mechanical, architectural, or structural markets. Residential construction markets may also be classified by the type of client or type of structure being built such as retirement and handicapped accessible housing, high-end custom buildings, room and building design, or remodeling.

From the markets identified at step S302, at step S304, on the micro level, businesses are identified that can legally introduce the innovation in an applicable market. These businesses may include corporations that are already established in an applicable industry on an international or global level, which includes the country where the innovation originated. Selecting an already established international business may reduce the time to implementing the innovation on an international level so these types of businesses may be given higher priority. In addition, businesses may be sought out that have not operated on an international level but have the desire and the legal ability to do so.

At step S308, the cultural factors associated with innovation commercialization are matched to the innovation information across global, macro, and micro domains. On the global level at S300, countries are identified that have a positive cultural attitude toward international business. According to one implementation, this positive cultural attitude may be manifested by a country's liberal incorporation laws with regard to international companies. A country's positive attitude toward international business may also be shown by the number of international businesses currently operating in that country.

From the countries identified at step S300, at step S302, markets are identified with at least one supply chain practice that is related to the innovation. According to one implementation where the innovation is in the residential construction industry, supply chain practices may include the methods of acquisition and manufacture of raw materials, manufacturing of components, methods of distribution to consumers, and plans for waste management and recycling.

From the markets identified at step S302, at step S304, on the micro level, businesses are identified with a predetermined corporate culture that supports the implementation of the innovation. Aspects of a company's corporate culture that may be matched to the originator of the innovation include the level of priority the company gives to job safety, methods of communication within the company, and whether or not the company has a centralized or decentralized organizational structure.

At step S310, the economic factors associated with innovation commercialization are matched to the innovation information across global, macro, and micro domains. On the global level at step S300, countries are identified that have fast-growing economies that could support international commercialization. Factors that affect this determination include gross domestic product (GDP) of the country, money supply, banking structure, current employment statistics, average labor costs, housing starts, and the current and predicted status of the country's real estate market.

From the countries identified at step S300, at step S302, markets are identified that have a predetermined amount of value to be added by the innovation. For instance, by performing surveys and market analyses, it may be possible to determine markets in an industry that are most ripe for growth. In one implementation pertaining to the residential construction industry, in places with climates that are well-suited to solar power and whose consumers show in interest in residential solar energy, there may stand a large amount of value to be added by innovations in the residential solar energy market.

From the markets identified at step S302, at step S304, on the micro level, businesses are identified with a forecasted economic profit arising out of the innovation. To continue with the previous example discussed above, in the instance of a residential construction innovation in the residential solar energy market, businesses that specialize in the installation and maintenance of residential solar panels and systems pertaining thereto are identified as possible candidates for implementing the innovation.

The political, cultural, and economic factors that are used in the needs and offers matching phase at step S206 are retrieved from a database 6 or manually input by a user. Once the political, cultural, and economic factors have been identified, the countries, markets, and businesses that are matched to the innovation information are identified by the server 4 through a web crawling process. This web crawling process harvests information from the internet pertaining to the one or more countries, markets, and businesses that are being considered for commercializing the innovation. For example, at step S310, the web crawling process can identify a list of countries whose GDP is above a predetermined threshold, and whose unemployment rate is below another predetermined threshold.

When the three lists of international businesses have been generated according to the political, cultural, and economic frameworks, a comparison of the three lists is conducted by the processing circuitry. In one embodiment, the international businesses that appear on all three lists are those that are considered for implementation of the innovation and are output to the user via an interface at a computer 2 or mobile device 8 at step S208 as well input to the stakeholders networking phase at step S212. The originator of the innovation may then select one or more of the matched international businesses for executing the commercialization of the innovation.

According to the following implementation, the needs and offers matching phase at step S206 is executed on a global level for an innovation. The user may specify that only countries with low levels of political unrest may be considered. With this criteria, at step S306, the sever 4 may generate a list of countries that include Japan, Switzerland, Canada, Singapore, New Zealand, or the United Arab Emirates. However, the user may be willing to accept the risks associated with countries that have a higher level of political unrest. In this circumstance, the server 4 may generate a list that includes the previously listed countries plus additional countries such as Belize, Ireland, Thailand, India, or Israel.

At step S308, the server 4 generates a list of countries whose culture may support international business. This may be manifested by countries that place a high priority on innovation or have a low amount of red tape for entrepreneurs who are starting businesses. The list generated by the server 4 may include New Zealand, Hong Kong, Singapore, Australia, Canada, Taiwan, or Ireland. At step 310, the server generates a list of countries whose economies support international business. The user may specify a threshold for an acceptable GDP or GDP growth rate, and the server 4 generates a list of countries that meet the thresholds specified by the user. The list generated by the server 4 may include Japan, China, New Zealand, India and Canada.

Once the list of countries has been generated based on the political, cultural, and economic factors, the processing circuitry compares the lists based on criteria specified by the user. According to this example, if the user specifies that only countries appearing on all three lists will be considered for commercializing the innovation, then only New Zealand and Canada will be considered. If the user specifies that countries on two of the three lists will be considered for commercializing the innovation, then Japan and India will also be considered.

An information flow diagram for performing the stakeholders networking phase at step S212 of internationally commercializing an innovation is described by FIG. 3B. Descriptive information pertaining to the one or more matched international businesses selected by the originator of the innovation at step S208 is input to the stakeholders networking phase at step S212. At step S210, the server 4 outputs data pertaining to preferred business partners, tasks to be performed, and resources to be acquired that are retrieved from a database 6 along with any information manually input at computer 2 by the user. This data obtained at step S210 is then used as an input to the stakeholders networking phase at step S212.

At step 312, a list of one or more stakeholders who are a part of one or more construction disciplines is determined. At step S314, a categorized list identifying one or more activities to be performed is displayed to the one or more stakeholders via a computer 2 or a mobile device 8. At step S316, a categorized list identifying one or more resources to be allocated is displayed to the one or more stakeholders via a computer 2 or a mobile device 8. The stakeholders then negotiate with each other via an interface at a computer 2 or mobile device 8 via the server 4 to distribute the tasks and resources among each other. The list of distributed tasks and resources is output by the server 4 at step S214. Any of the steps of the stakeholders networking phase of step S212 may be performed in series, concurrently, or in a different order according to other implementations. Further exemplary details of determining the list of stakeholders at step S312, the list of activities at step S314, and the list of resources at step S316 are described below.

At step S312, the server 4 identifies one or more potential business partners. According to one implementation where the innovation is in the residential construction industry, these potential business partners are a part of one or more construction disciplines. The server 4 conducts a web crawling process to harvest information from the internet pertaining to the one or more potential business partners that may include company name, contact information, number of years in business, company size, construction specialties, and the like as would be recognized by one of skill in the art. The originator of the innovation may also manually input information regarding any known potential business partners. The potential business partners identified by the server 4 may have a better knowledge of the local market than the originator of the innovation and are a part of the innovation's supply chain. Any information regarding preferred business partners that was manually input by the user at step S210 is also incorporated to the list of preferred business partners at step S312. Once the potential business partners agree to assist with the implementation of the innovation, they are referred to as stakeholders. These stakeholders then assist the originator of the innovation with selecting a suitable market entry mode. According to one implementation, an innovation may have been developed that introduces a new type of polymer roof shingle. Some preferred business partners may include roofers, roofing manufacturers, cement manufacturers, lumber manufacturers, roofing adhesive manufacturers, and the like as would be recognized by one of skill in the art.

At step S314, the server 4 identifies one or more activities to be performed while commercializing the innovation. These activities may be retrieved from a database 6 or manually input at a computer 2 by a user. The server 4 may also conduct a web crawling process to harvest information from the internet pertaining to the one or more activities that may be performed by searching for key words on websites related to the residential construction industry. According to an implementation in the residential construction industry, some of these activities may include the manufacture of specialized components that are a part of the innovation. An assessment is also made of whether new business partners should be added to the group of stakeholders to carry out the list of identified activities. Once a categorized list of activities has been determined, the stakeholders negotiate with each other via an interface at a computer 2 or mobile device 8 connected to the server 4 to distribute the activities among each other.

At step S316, the server 4 identifies one or more resources to be obtained while commercializing the innovation. The list of resources may be retrieved from a database 6 or manually input at a computer 2 by a user. The server 4 may also conduct a web crawling process to harvest information from the internet pertaining to the one or more resources that may be obtained by searching for key words on websites related to the residential construction industry. According to an implementation of a residential construction innovation, some of these resources may include various parts and materials that are a part of the innovation or other specialized equipment needed to implement the innovation. An assessment is also made of whether new business partners should be added to the group of stakeholders to acquire the identified resources. Once a categorized list of resources has been developed, the stakeholders negotiate with each other via an interface at a computer 2 or mobile device 8 connected to a server to distribute the resources among each other.

An information flow diagram for performing the feasibility study phase at step S218 of internationally commercializing an innovation is described by FIG. 4. The list of tasks and resources that are distributed among the stakeholders output by the server 4 at step S214 is input to the feasibility study phase at step S218. At step S216, the server 4 outputs data pertaining to technical, marketing, and business details of commercializing the innovation retrieved from a database 6 that delineate the practical aspects of commercializing the innovation. The technical, marketing, and business data obtained at step S216 is then input to the feasibility study phase at step S218.

The purpose of the feasibility study phase is to create a feasibility report along with an actual business plan to indicate to the stakeholders the feasibility of executing the commercialization of the innovation. The feasibility report gives focus to the project, identifies reasons not to proceed, and enhances the probability of success by addressing and mitigating factors early on that could affect the project. Any of the steps of the feasibility study phase at step S218 may be performed in series, concurrently, or in a different order according to other implementations. Further exemplary details of the technical, marketing, and business data of step S216 are described below.

The technical data input by the user at step S216 is used to develop the technical portion of the feasibility report at step S400. The technical aspects of the negotiated tasks and resources from the stakeholders networking phase at step S212 may also be used to develop the technical portion of the feasibility report at step S400. This portion of the report includes details of the product design as well as the technical processes that are used to implement the innovation. The server 4 can retrieve a template for the technical portion of the feasibility report from a database 6, and the technical data that is input may be used to populate predetermined fields in the report. In one example of a residential construction innovation, for the product design report template, the user may be able to upload technical drawings of the innovation and specify the materials required to produce the products associated with the innovation along with relative quantities and associated costs.

At step S402, the marketing data input by the user at step S216 is used to develop the marketing portion of the feasibility report. The marketing aspects of the negotiated tasks and resources from the stakeholders networking phase at step S212 may also be used to develop the marketing portion of the feasibility report at step S402. This portion of the report includes details of the innovation's market fit and segmentation, which may include profiles of potential consumers and methods of marketing the innovation to those consumers. The server 4 can retrieve a template for the marketing portion of the feasibility report from a database 6, and the marketing data that is input may be used to populate predetermined fields in the report. In one example of a residential construction innovation, for the marketing plan template, the user may be able to specify one or more marketing methods, primary consumers, and costs associated with each marketing method.

At step S404, the business data input by the user at step S216 is used to develop the business portion of the feasibility report. The business aspects of the negotiated tasks and resources from the stakeholders networking phase at step S212 may also be used to develop the business portion of the feasibility report at step S404. This portion of the report includes details of supply chain configuration, hierarchical structure of the business including roles and responsibilities of the employees, financial and accounting information, and legal protections that may be necessary. The server 4 can retrieve a template for the marketing portion of the feasibility report from a database 6, and the business data that is input may be used to populate predetermined fields in the report. In one example of a residential construction innovation, for the business structure template, the user may be able to specify the organizational structure of the business, which may include type and number of employees along with corresponding salaries and/or wages.

In addition to the technical, marketing, and business portions of the feasibility report, another aspect of the feasibility study phase at step S218 is a computation of return on investment, anticipated profits from prime consumers, and/or costs associated with government regulations based surveys of the one or more stakeholders, current economic trends, and predictions about the future economic environment.

Once the feasibility report has been developed during the feasibility study phase at step S218, this report is output at step S220 along with a business plan for the implementation and execution of commercializing the innovation. This business plan incorporates the technical, marketing, and business aspects of the feasibility report, and covers all phases of product development, which may include planning, planning reviews, early production, production reviews, product standardization, and potential product maturation. The server 4 can retrieve a template for the business plan from a database 6, the data that is used to populate predetermined fields in the business plan may come directly from the feasibility report or may be manually input by the user at a computer 2. This business plan is displayed to the user via an interface at a computer 2 or mobile device 8. The feasibility report and business plan output at step S220 are used by the stakeholders to make the final decision whether to move forward with commercializing the innovation.

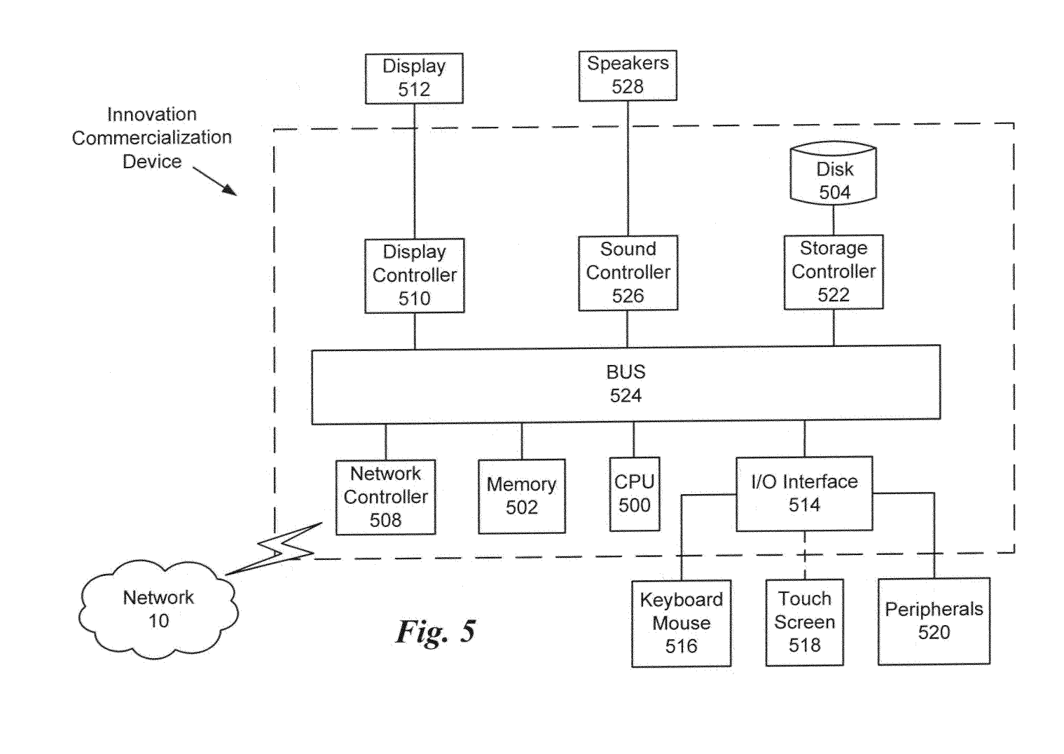

Next, a hardware description of the innovation commercialization device is described with reference to FIG. 5. In FIG. 5, the innovation commercialization device includes a CPU 500 which performs the processes described above. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer aided design station communicates, such as a server or computer.

Further, the claimed advancements may be provided as a utility application, background daemon, or component of an operating system, or combination thereof, executing in conjunction with CPU 500 and an operating system such as Microsoft Windows 7, UNIX, Solaris, LINUX, Apple MAC-OS and other systems known to those skilled in the art.

CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The innovation commercialization device in FIG. 5 also includes a network controller 508, such as an Intel Ethernet PRO network interface card from Intel Corporation of America, for interfacing with network 10. As can be appreciated, the network 10 can be a public network, such as the Internet, or a private network such as an LAN or WAN network, or any combination thereof and can also include PSTN or ISDN sub-networks. The network 10 can also be wired, such as an Ethernet network, or can be wireless such as a cellular network including EDGE, 3G and 4G wireless cellular systems. The wireless network can also be WiFi, Bluetooth, or any other wireless form of communication that is known.

The innovation commercialization device further includes a display controller 510, such as a NVIDIA GeForce GTX or Quadro graphics adaptor from NVIDIA Corporation of America for interfacing with display 512, such as a Hewlett Packard HPL2445w LCD monitor. A general purpose I/O interface 514 interfaces with a keyboard and/or mouse 516 as well as a touch screen panel 518 on or separate from display 512. General purpose I/O interface also connects to a variety of peripherals 520 including printers and scanners, such as an OfficeJet or DeskJet from Hewlett Packard.

A sound controller 526 is also provided in the innovation commercialization device, such as Sound Blaster X-Fi Titanium from Creative, to interface with speakers/microphone 528 thereby providing sounds and/or music.

The general purpose storage controller 522 connects the storage medium disk 504 with communication bus 524, which may be an ISA, EISA, VESA, PCI, or similar, for interconnecting all of the components of the innovation commercialization device. A description of the general features and functionality of the display 512, keyboard and/or mouse 516, as well as the display controller 510, storage controller 522, network controller 508, sound controller 526, and general purpose I/O interface 514 is omitted herein for brevity as these features are known.

Any processes, descriptions or blocks in flowcharts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order depending upon the functionality involved.

Obviously, numerous modifications and variations of the present advancements are possible in light of the above teachings. It is therefore to be understood that within the scope of the appended claims, the present advancements may be practiced otherwise than as specifically described herein.

1. A method implemented by at least one server for internationally commercializing an innovation, the method comprising:
a) receiving, at at least one server, innovation information pertaining to at least one benefit that the innovation would offer an international market;
b) identifying, at the at least one server, one or more cultural, political, and/or economic factors pertaining to at least one country, at least one market, and/or at least one business where the innovation could be implemented;
c) identifying, at the at least one server, at least one country, at least one market, and/or at least one business that satisfy the one or more cultural, political, and/or economic factors;
d) matching the innovation information to the at least one country, at least one market, and/or at least one business that satisfy the one or more cultural, political, and/or economic factors to generate a list of businesses that could implement the innovation;
e) identifying, at the at least one server, one or more stakeholders based on one or more shared characteristics with the innovation;
f) identifying, at the at least one server, one or more activities that may be executed by the one or more stakeholders while commercializing the innovation;
g) identifying, at the at least one server, one or more resources required to commercialize the innovation;
h) determining, at the at least one server, a categorized list identifying one or more activities and/or resources to be distributed among the one or more stakeholders;
i) identifying, at the at least one server, technical, marketing, and/or business attributes of the innovation based on the distribution of activities and/or resources among the one or more stakeholders;
j) calculating, at the at least one server, return on investment, anticipated profits from consumers, and/or costs associated with government regulations based on surveys of the one or more stakeholders, current economic trends, and predictions about the future economic environment; and
k) serving, from the server to a client device, a technical, marketing, and/or economic feasibility report and business plan indicating to the one or more stakeholders the feasibility of executing the innovation with the at least one international business.

2. The method of claim 1, wherein the innovation is a residential construction industry innovation.

3. The method of claim 1, wherein step (b) includes identifying one or more cultural, political, and economic factors pertaining to the at least one country, the at least one market, and the at least one business where the innovation could be implemented.

4. The method of claim 1, wherein step (c) further includes identifying at least one country with a predetermined political environment and legal structure, a predetermined cultural attitude, and economic growth that supports international commercialization.

5. The method of claim 4, wherein step (c) further includes identifying at least one international market with a predetermined standard of regulation by a local government, at least one supply chain practice that is related to the innovation, and a predetermined amount of value to be added by the innovation.

6. The method of claim 5, wherein step (b) further includes identifying at least one international business having legal authority to implement the innovation, having a predetermined corporate culture, and having a forecasted economic profit arising out of the innovation.

7. The method of claim 1, which further comprises:
comparing the at least one country, the at least one market, and the at least one business that have been matched to the innovation information according to the one or more political, cultural, and/or economic factors.

8. The method of claim 7, wherein the identifying identifies the one or more stakeholders having the one or more shared characteristics with the innovation based on the at least one country, the at least one market, and the at least one business that have been matched.

9. The method of claim 1, wherein the one or more stakeholders are a part of at least one supply chain of the innovation.

10. The method of claim 1, wherein step (h) includes determining a categorized list identifying one or more activities and resources to be distributed among the one or more stakeholders.

11. The method of claim 1, wherein step (i) includes identifying, at the at least one server, technical, marketing, and business attributes of the innovation based on the distribution of activities and resources among the one or more stakeholders.

12. The method of claim 1, wherein step (j) includes calculating return on investment, anticipated profits from prime consumers, and costs associated with government regulations based surveys of the one or more stakeholders, current economic trends, and predictions about the future economic environment.

13. The method of claim 1, wherein step (k) includes serving, from the server to a client device, a technical, marketing, and economic feasibility report and business plan to the one or more stakeholders indicating the feasibility of executing the innovation with the at least one international business.

14. A non-transitory computer-readable medium having computer-readable instructions thereon which when executed by a computer cause the computer to perform a method for internationally commercializing an innovation, the method comprising:
a) receiving innovation information pertaining to at least one benefit that the innovation would offer an international market;
b) identifying one or more cultural, political, and/or economic factors pertaining to at least one country, at least one market, and/or at least one business where the innovation could be implemented;
c) identifying at least one country, at least one market, and/or at least one business that satisfy the one or more cultural, political, and/or economic factors;
d) matching the innovation information to the at least one country, at least one market, and/or at least one business that satisfy the one or more cultural, political, and/or economic factors to generate a list of businesses that could implement the innovation;
e) identifying one or more stakeholders based on one or more shared characteristics with the innovation;
f) identifying one or more activities that may be executed by the one or more stakeholders while commercializing the innovation;
g) identifying one or more resources required to commercialize the innovation;
h) determining a categorized list identifying one or more activities and/or resources to be distributed among the one or more stakeholders;
i) identifying technical, marketing, and/or business attributes of the innovation based on the distribution of activities and/or resources among the one or more stakeholders;
j) calculating return on investment, anticipated profits from consumers, and/or costs associated with government regulations based on surveys of the one or more stakeholders, current economic trends, and predictions about the future economic environment; and
k) serving, from the server to a client device, a technical, marketing, and/or economic feasibility report and business plan indicating to the one or more stakeholders the feasibility of executing the innovation with the at least one international business.

15. An apparatus having one or more servers for internationally commercializing an innovation, the apparatus comprising:
processing circuitry configured to:
receive innovation information pertaining to at least one benefit that the innovation would offer an international market;
identify one or more cultural, political, and/or economic factors pertaining to at least one country, at least one market, and/or at least one business where the innovation could be implemented;
identify at least one country, at least one market, and/or at least one business that satisfy the one or more cultural, political, and/or economic factors;
match the innovation information to the at least one country, at least one market, and/or at least one business that satisfy the one or more cultural, political, and/or economic factors.
identify one or more stakeholders based on one or more shared characteristics with the innovation;
identify one or more activities that may be executed by the one or more stakeholders while commercializing the innovation;
identify one or more resources required to commercialize the innovation;
determine a categorized list identifying one or more activities and/or resources to be distributed among the one or more stakeholders;
identify technical, marketing, and/or business attributes of the innovation based on the distribution of activities and/or resources among the one or more stakeholders;
calculate return on investment, anticipated profits from consumers, and/or costs associated with government regulations based on surveys of the one or more stakeholders, current economic trends, and predictions about the future economic environment; and
serve a technical, marketing, and/or economic feasibility report and business plan indicating to the one or more stakeholders the feasibility of executing the innovation with the at least one international business.

16. The apparatus of claim 19, wherein the innovation is in the residential construction industry.

17. The apparatus of claim 15, wherein the processing circuitry is further configured to compare the at least one country, the at least one market, and the at least one business that have been matched to the innovation information according to the one or more political, cultural, and/or economic factors.

18. The apparatus of claim 17, wherein the processing circuitry is further configured to identify the one or more stakeholders having the one or more shared characteristics with the innovation based on the at least one country, the at least one market, and the at least one business that have been matched.

19. The apparatus of claim 15, wherein the one or more stakeholders are a part of at least one supply chain of the innovation.

20. The apparatus of claim 15, wherein the processing circuitry is further configured to determine a categorized list identifying one or more activities and resources to be distributed among the one or more stakeholders.
